(19) United States
(12) Patent Application Publication
(10) Pub. No.: US 2013/0227391 A1
(43) Pub. Date: Aug. 29, 2013

(54) METHOD AND APPARATUS FOR DISPLAYING WEBPAGE

(71) Applicant: Pantech Co., Ltd., (US)

(72) Inventors: Oh-Seob LIM, Suwon-si (KR); Tae-Yong Kim, Seoul (KR); Min-Che Cho, Suwon-si (KR)

(73) Assignee: Pantech Co., Ltd., Seoul (KR)

(21) Appl. No.: 13/728,436

(22) Filed: Dec. 27, 2012

(30) Foreign Application Priority Data
Feb. 29, 2012 (KR) 10-2012-0021400

(51) Int. Cl. G06F 17/22

(52) U.S. Cl. CPC G06F 17/2247
USPC 715/234

(57) ABSTRACT

An apparatus to display a webpage includes a storage device to store webpage data for displaying a webpage, a controller to determine a main paragraph of the webpage, and a display unit to display the main paragraph without rendering a non-main paragraph. A method that uses a processor to display a webpage includes loading text data of a webpage, determining, using the processor, a main paragraph of the webpage, rendering a sub element included in the main paragraph, and displaying the main paragraph including the sub element without rendering a non-main paragraph.

### CROSS-REFERENCE TO RELATED APPLICATION

This application claims priority from and the benefit under 35 U.S.C. §119(a) of Korean Patent Application No. 10-2012-0021400, filed on Feb. 29, 2012, which is hereby incorporated by reference for all purposes as if fully set forth herein.

### BACKGROUND

1. Field

The following description relates to a method and apparatus for providing a webpage, and more particularly, to a method and apparatus for providing an optimized webpage through a browser.

2. Discussion of the Background

A general browser loads and renders all elements constituting a webpage and displays the loaded and rendered elements on a screen. For example, the browser displays not only a main element, such as a news article or blog in which a user is interested, but also a sub element including an image, audio or video type content for advertisement or decoration. Thus, the browser loads and renders even a sub element not related to an important content in the webpage, and therefore the performance of a system may be degraded due to the use of a data network and a system resource for rendering less important content. Further, it may cause a delay for the user to see the webpage due to the rendering of less important sub elements.

Further, a user may set a setup function that blocks all sub elements, e.g., multimedia contents in a webpage not to be loaded. However, regardless of a user's intention, all the multimedia contents in the webpage may be excluded from an object to be loaded and rendered according to the setup function. Thus, the user may not see even a multimedia content included in the main element, and it may cause an inconvenience that the user should change a setup to identify the excluded content and reload the corresponding webpage to see the multimedia content included in the main element.

Further, in a device such as a smart phone having a small-sized screen of a display, the size of the display of the device is limited when a webpage is displayed on the screen. A large number of contents should be displayed on the screen of the display having the limited size, and therefore, inconvenience in the use of the webpage may be experienced. Thus, a user may want to load a main element of a webpage on the screen without displaying sub elements not related to the main element.

### SUMMARY

The following description relates to a method and apparatus for creating and displaying a webpage. The method and apparatus may provide a webpage optimized to render and load a main paragraph without rendering sub elements not related to the main element.

Additional features of the invention will be set forth in part in the description which follows and, in part, will be apparent from the description, or may be learned by practice of the invention.

Exemplary embodiments of the present invention provide an apparatus to display a webpage including a storage device to store webpage data for displaying a webpage, a controller to determine a main paragraph of the webpage, and a display unit to display the main paragraph without rendering a non-main paragraph.

Exemplary embodiments of the present invention provide a method that uses a processor to display a webpage including loading text data of a webpage, determining, using the processor, a main paragraph of the webpage, rendering a sub element included in the main paragraph, and displaying the main paragraph including the sub element without rendering a non-main paragraph.

Exemplary embodiments of the present invention provide an apparatus to display a webpage including a storage device to store webpage data for displaying a webpage, a controller to load text data of the webpage, to determine a main paragraph of the webpage, and to selectively render a sub element included in the main paragraph, and a display unit to display the main paragraph and the rendered sub element.

It is to be understood that both forgoing general descriptions and the following detailed description are exemplary and explanatory and are intended to provide further explanation of the invention as claimed. Other features and aspects will be apparent from the following detailed description, the drawings, and the claims.

### BRIEF DESCRIPTION OF THE DRAWINGS

The accompanying drawings, which are included to provide a further understanding of the invention and are incorporated in and constitute a part of this specification, illustrate embodiments of the invention, and together with the description serve to explain the principles of the invention.

FIG. 1 is a diagram illustrating a system for providing a webpage according to an exemplary embodiment of the present invention.

FIG. 2 is a diagram illustrating a configuration of an apparatus for optimizing a webpage according to an exemplary embodiment of the present invention.

FIG. 3 is a flowchart illustrating a method for optimizing a web element for loading and rendering through a determination of a main paragraph according to an exemplary embodiment of the present invention.

FIG. 4 is a flowchart illustrating a method for extracting a main paragraph according to an exemplary embodiment of the present invention.

FIG. 5 is a diagram illustrating a web source code for extracting a main paragraph and a screen of a webpage corresponding to the web source code according to an exemplary embodiment of the present invention.

FIG. 6 is a flowchart illustrating a method for extracting a main paragraph according to an exemplary embodiment of the present invention.

FIG. 7 is a diagram illustrating a web source code for extracting the main paragraph and a screen of a webpage corresponding to the web source code according to an exemplary embodiment of the present invention.

FIG. 8 is a flowchart illustrating a method for extracting a main paragraph according to an exemplary embodiment of the present invention.

FIG. 9 is a diagram illustrating a method for determining a main paragraph in a screen of a webpage based on a link of the previous webpage according to an exemplary embodiment of the present invention.

FIG. 10 is a diagram illustrating a web source code of the webpage including a source code corresponding to a main paragraph according to an exemplary embodiment of the present invention.

FIG. 11 is a flowchart illustrating a method for extracting a main paragraph according to an exemplary embodiment of the present invention.

FIG. 12 is a diagram illustrating a screen of a webpage for extracting the main paragraph and a database included in a main paragraph information storage unit according to an exemplary embodiment of the present invention.

FIG. 13 is a flowchart illustrating a method for extracting a main paragraph according to an exemplary embodiment of the present invention.

FIG. 14 is a diagram illustrating a screen of a webpage displaying an interaction between a user and an apparatus for creating an optimized webpage according to an exemplary embodiment of the present invention.

FIG. 15 is a diagram illustrating a process of displaying a replacement element in replacement of a sub element not included in a main paragraph according to an exemplary embodiment of the present invention.

FIG. 16 is a flowchart illustrating a method for storing main paragraph information on a main paragraph selected by a user according to an exemplary embodiment of the present invention.

FIG. 17 is a diagram illustrating a screen of a webpage displaying an interaction between a user and an apparatus for creating a webpage which stores information on the main paragraph selected by the user according to an exemplary embodiment of the present invention.

FIG. 18 is a flowchart illustrating a method for displaying a sub element of a paragraph not associated with a main paragraph or not included in the web element loading and rendering optimization according to an exemplary embodiment of the present invention.

### DETAILED DESCRIPTION OF THE ILLUSTRATED EMBODIMENTS

Exemplary embodiments now will be described more fully hereinafter with reference to the accompanying drawings, in which exemplary embodiments are shown. The present disclosure may, however, be embodied in many different forms and should not be construed as limited to the exemplary embodiments set forth therein. Rather, these exemplary embodiments are provided so that the present disclosure will be thorough and complete, and will fully convey the scope of the present disclosure to those skilled in the art. In the description, details of well-known features and techniques may be omitted to avoid unnecessarily obscuring the presented embodiments.

The terminology used herein is for the purpose of describing particular embodiments only and is not intended to be limiting of the present disclosure. As used herein, the singular forms “a”, “an” and “the” are intended to include the plural forms as well, unless the context clearly indicates otherwise. Furthermore, the use of the terms a, an, etc. does not denote a limitation of quantity, but rather denotes the presence of at least one of the referenced item. The use of the terms “first”, “second”, and the like does not imply any particular order, but they are included to identify individual elements. Moreover, the use of the terms first, second, etc. does not denote any order or importance, but rather the terms first, second, etc. are used to distinguish one element from another. It will be further understood that the terms “comprises” and/or “comprising”, or “includes” and/or “including” when used in this specification, specify the presence of stated features, regions, integers, steps, operations, elements, and/or components, but do not preclude the presence or addition of one or more other features, regions, integers, steps, operations, elements, components, and/or groups thereof. It will be understood that for the purposes of this disclosure, “at least one of” will be interpreted to mean any combination the enumerated elements following the respective language, including combination of multiples of the enumerated elements. For example, “at least one of X, Y, and Z” will be construed to mean X only, Y only, Z only, or any combination of two or more items X, Y, and Z (e.g. XYZ, XZ, XZZ, YZ, XX).

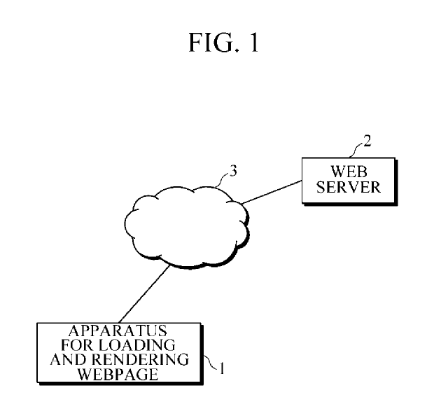

FIG. 1 is a diagram illustrating a system for providing a webpage according to an exemplary embodiment of the present invention.

Referring to FIG. 1, the system includes an apparatus 1 for loading and rendering a webpage, a web server 2 and a communication network 3, such as the Internet network.

The web server 2 provides stored webpages to the apparatus 1 through the communication network 3. The webpages refer to electronic documents optimized to be displayed via a web browser. Generally, the webpages stored on the web server 2 may be accessed via the World Wide Web (WWW). Most of the webpages have a structure that may be divided into main elements and sub elements. The main elements may be text-based webpage elements in a webpage. For example, the main elements may include a hyper-text markup is language (hereinafter, referred to as an ‘HTML’), cascading style sheet (CSS) or Java script. The main element may be referred to as a source element. The sub elements may be non-text based webpage elements in a webpage. For example, the sub elements may be elements of an image, audio or video format. The sub elements may include elements for advertisement or decoration on the webpages. A webpage may be optimized in loading and rendering processes so that a portion of the sub elements may not be rendered and displayed on a webpage. Through the webpage optimization, the use of system resources, a webpage load time, and/or data traffic for loading a webpage may be reduced.

The apparatus 1 may include various types of devices that provide a browser capable of displaying a webpage and receive webpage data. The browser includes an application program that enables a user to see a webpage provided through the communication network 3, and/or a client program for receiving webpage data provided from the web server 2 and processing the received webpage data.

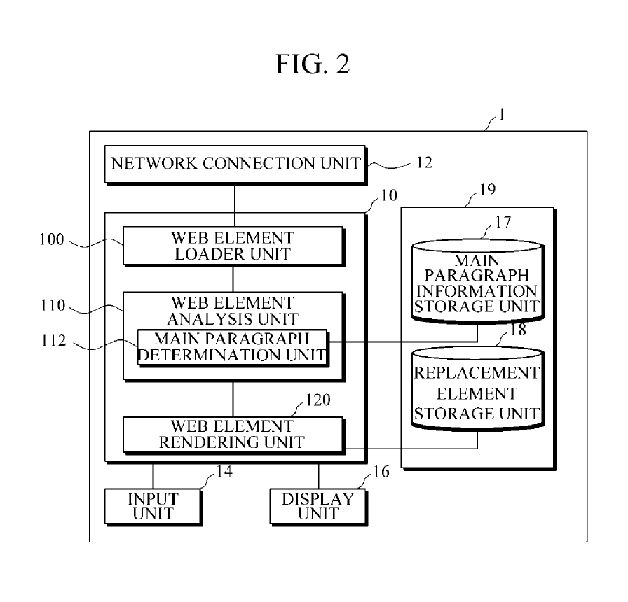

FIG. 2 is a diagram illustrating a configuration of an apparatus for optimizing a webpage according to an exemplary embodiment of the present invention.

Referring to FIG. 2, the apparatus 1 includes a control unit 10, a network connection unit 12, an input unit 14, a display unit 16, and a storage unit 19.

The configuration of the apparatus 1 may be changed and other components or elements may be included in the apparatus 1 for implementing an operation for optimizing webpage display in the apparatus 1 and features shown may not be necessary for implementation of aspects of the present invention. The components or elements added to the apparatus 1 may be determined according to the kind or function of the apparatus 1. The apparatus 1 may be a user terminal, such as a mobile phone, a tablet computer, a personal computer, a personal digital assistant (PDA), and the like.

The network connection unit 12 may request webpage data from the web server 2 through the communication network 3 and may receive the webpage data from the web server 2 through the communication network 3. The webpage data may be received via wired communication network or wireless communication network (e.g., wired internet connections, the third generation mobile communication network (3G), the fourth generation mobile communication network (4G), Wi-Fi, and the like).

The control unit 10 may load a webpage based on webpage data provided from the network connection unit 12 and analyze the webpage. The control unit 10 may perform rendering of the webpage based on an analyzed result and may display a rendered result on a screen through the display unit 16. The control unit 10 may determine a main paragraph of the webpage, and may selectively load and render webpage elements so that the main paragraph is selectively displayed on the screen.

Further, the control unit 10 may include a web element loader unit 100, a web element analysis unit 110, and a web element rendering unit 120. The web element analysis unit 110 may include a main paragraph determination unit 112 for determining a main paragraph based on the analyzed result.

The web element loader unit 100 may provide, to the web element analysis unit 110, web elements provided from the network connection unit 12. Further, the web element loader unit 100 may receive main elements and sub elements from the network connection unit 12 and loads the received main and sub elements. The web element loader unit 100 may load the main elements and may determine whether to load the sub elements. The web element loader unit 100 may load a sub element associated with the main paragraph among the sub elements.

The web element analysis unit 110 may analyze web elements provided from the web element loader 100 and may provide an analyzed result to the web element rendering unit 120 so as to display a portion of or all the analyzed web elements on the screen. Further, the web element analysis unit 110 may analyze a main element that is one of the web elements and structured nodes constituting the main element using a relationship among the nodes. A web document is composed of objects describing the web document, and each of the objects is referred to as a node. The nodes are structured through connection links. The structured nodes are called as a document object model (hereinafter, referred to as a ‘DOM’) node tree. A webpage may be analyzed as a DOM node tree, and the browser may search nodes of the analyzed DOM node tree for predetermined nodes, and access attributes, such as the name and value of a node. DOM is an application programming interface (API) for accessing a logical structure of a document, such as an HTML document. A programmer may create a document, and adjust, add, modify or delete components and contents of the document.

The main paragraph determination unit 112 may distinguish paragraphs from text-based elements. The main paragraph determination unit 112 may determine a main paragraph among the paragraphs constituting a webpage to be displayed on a screen, and may distinguish the main paragraph from the paragraphs. Further, a sub element associated with the main paragraph may not be excluded from an object to be loaded and rendered. A sub element that is not associated with the main paragraph may be excluded from the object to be loaded and rendered, or may be replaced with a replacement element. By determining the object to be loaded and uploaded, the webpage may be provided to a user by loading and rendering the main paragraph including a sub element associated with the main paragraph without damaging the layout of the webpage.

If all sub elements in a webpage, e.g., all multimedia contents, are blocked for loading and rendering, a multimedia content associated with a main paragraph of the webpage may also be blocked and not be loaded. In this configuration, there may be an inconvenience for a user to load the blocked multimedia content associated with the main paragraph. In order to see the blocked multimedia content, the user may need to change settings and reload the corresponding webpage so as to identify the excluded contents. To address this problem, the main paragraph determination unit 112 may determine a main paragraph in a webpage, determine a sub element associated with the main paragraph to be included in an object to be loaded and rendered, and determine the main paragraph including the sub element associated with the main paragraph, thereby optimizing a webpage object to be provided to the user. The main paragraph determining unit 112 may determine more than one sub element associated with the main paragraph.

The web element rendering unit 120 may process web elements as a webpage to be displayed on a screen of the display unit 16. The web elements may be loaded through the web element loader unit 100 and analyzed by the web element analysis unit 110. A display screen of the webpage may be determined using information on the screen positions and sizes of the web elements. The display unit 16 may receive the webpage rendered in the web element rendering unit 120 and display the received webpage on the screen. The input unit 14 may receive a user input received by an input interface, such as a keypad, touch screen, a voice recognition device, and the like.

The storage unit 19 may include a main paragraph information storage unit 17 and a replacement element storage unit 18. If a user selects a main paragraph of a webpage or a main paragraph is determined by the main paragraph determination unit 112, the main paragraph information storage unit 17 may store information on the main paragraph. The information on the main paragraph may include a website address, a main paragraph tag, a tag position, a tag identification (ID), etc. The information on the main paragraph may be used as a reference when the main paragraph determination unit 112 determines a main paragraph of a webpage. The main paragraph determination unit 112 may search for a node corresponding to a main paragraph among nodes distinguished as paragraphs of a webpage using the information on the main paragraph stored in the main paragraph information storage unit 17.

The replacement element storage unit 18 may store a replacement sub element to replace the sub element not associated with the main paragraph determined by the main paragraph determination unit 112. The user may modify or store the replacement sub element stored in the replacement element storage unit 18 in a format determined by the user.

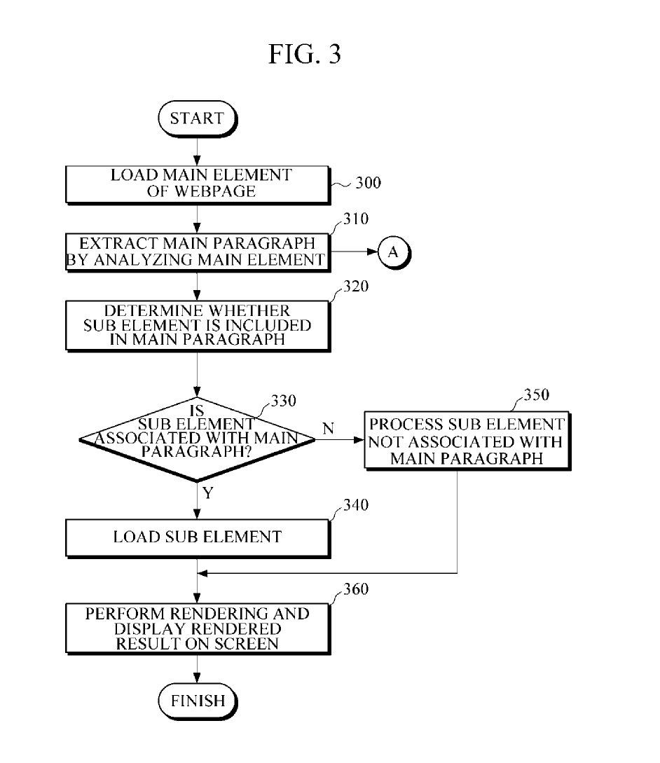

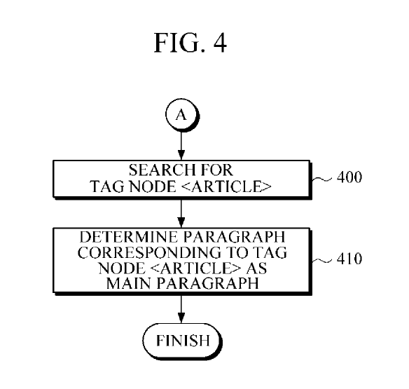

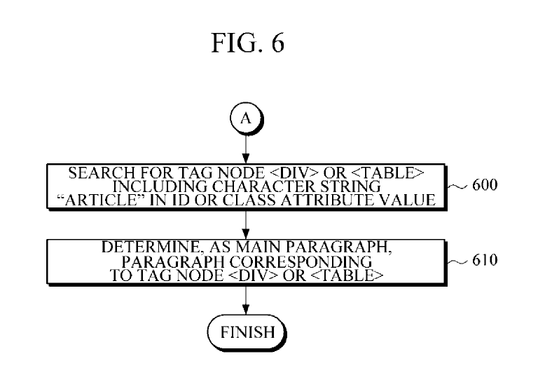

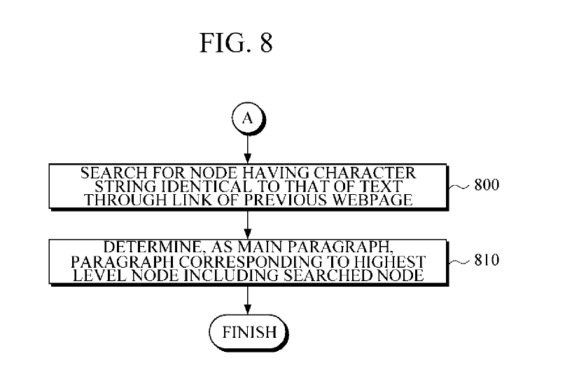

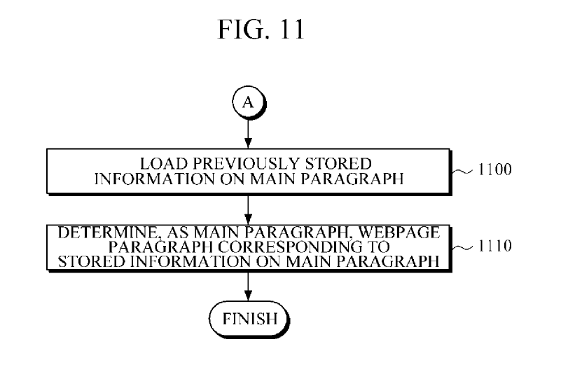

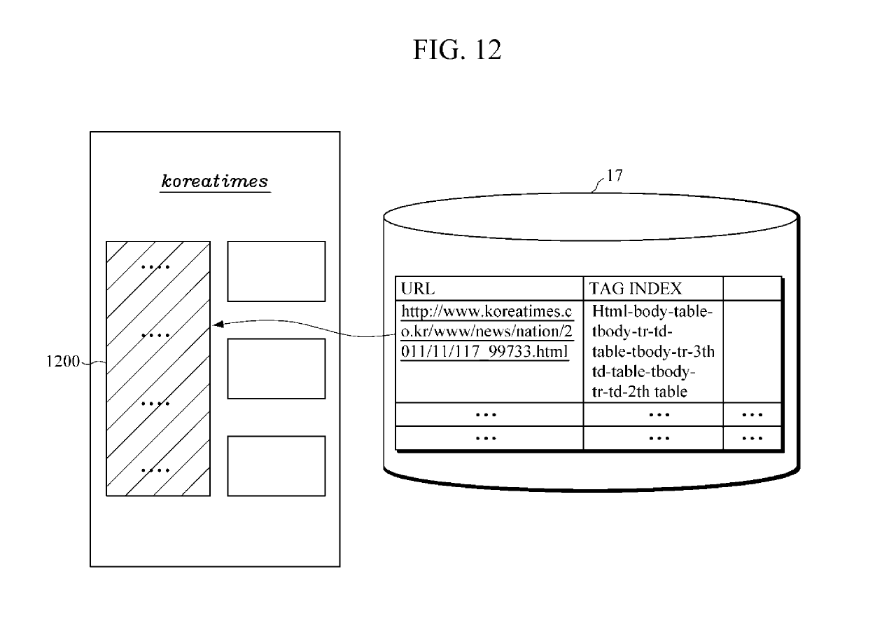

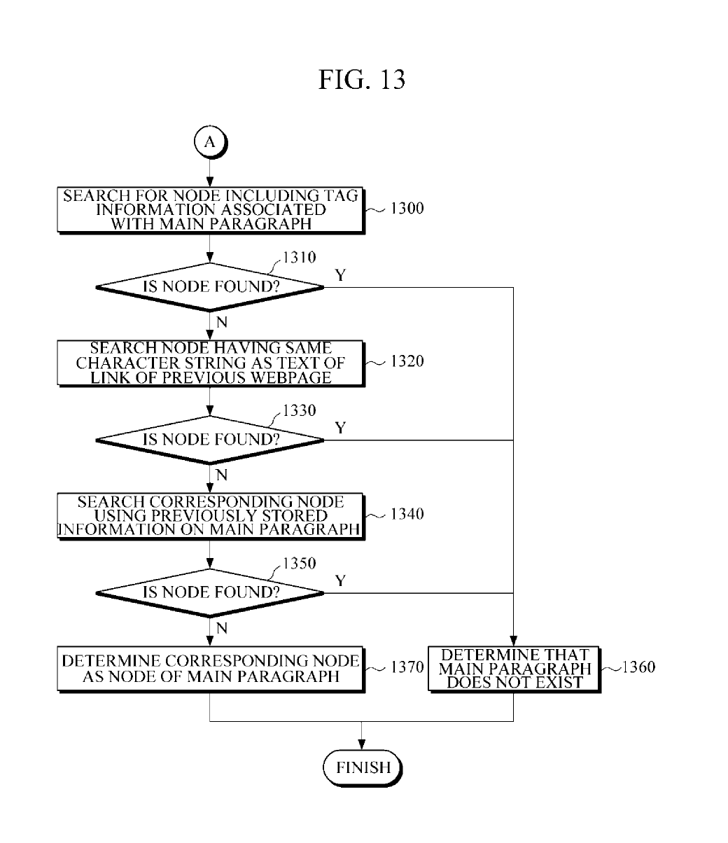

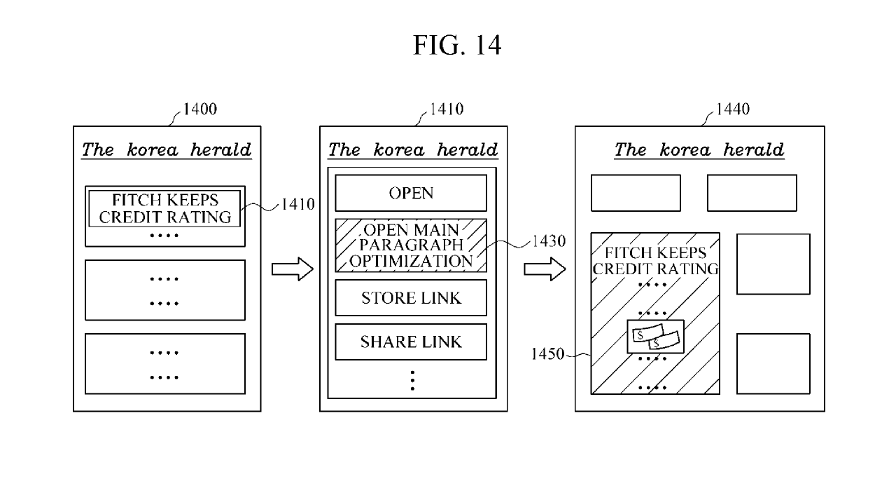

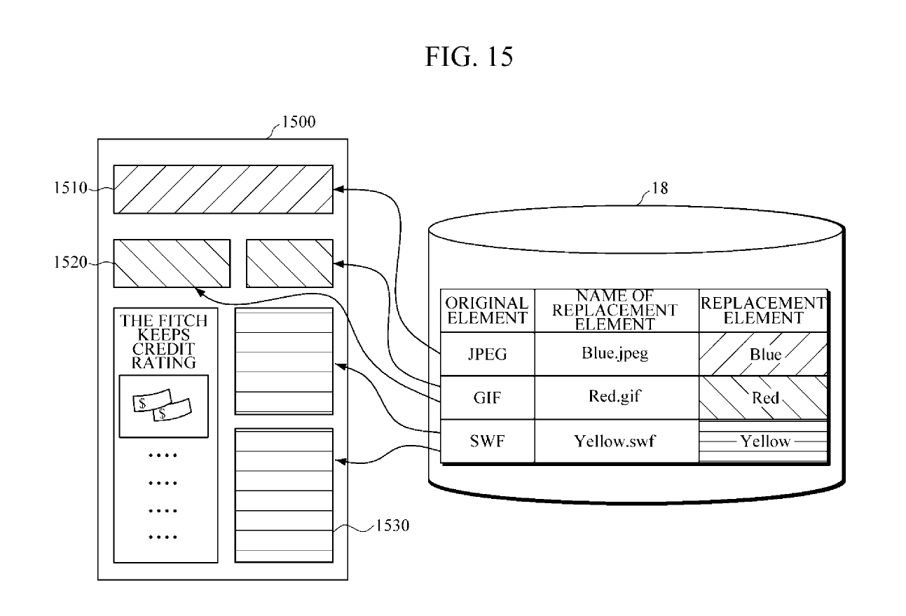

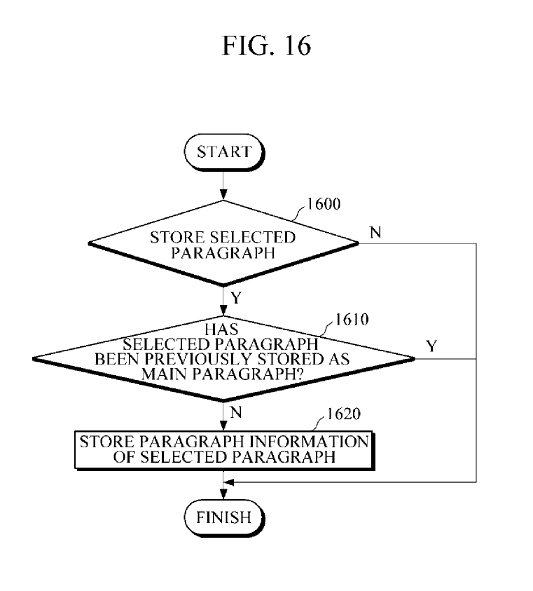

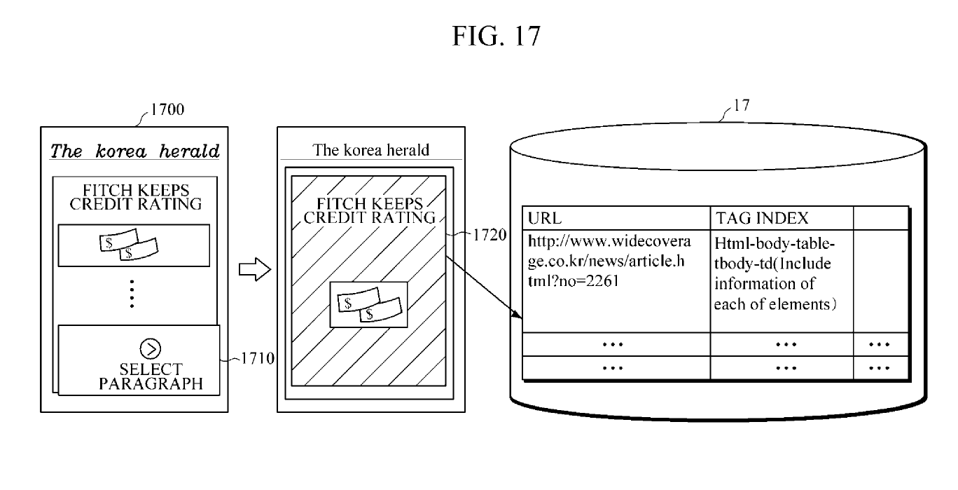

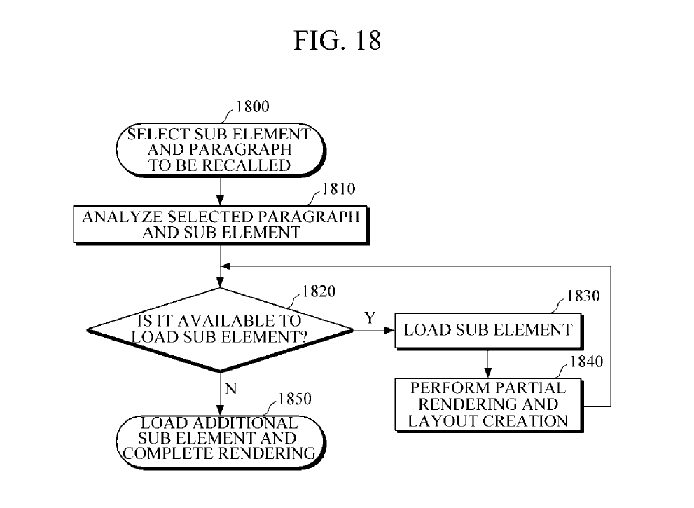

FIG. 3 is a flowchart illustrating a method for optimizing a web element for loading and rendering through a determination of a main paragraph according to an exemplary embodiment of the present invention. FIG. 3, FIG. 4, FIG. 6, FIG. 8, FIG. 11, FIG. 12, FIG. 13, FIG. 14, FIG. 15, FIG. 16, FIG. 17, and FIG. 18 will be described as if performed by the apparatus 1 shown in FIG. 2, but is not limited as such.

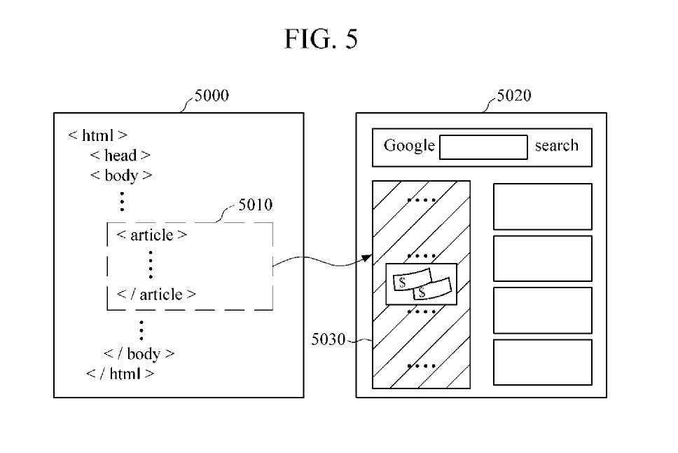

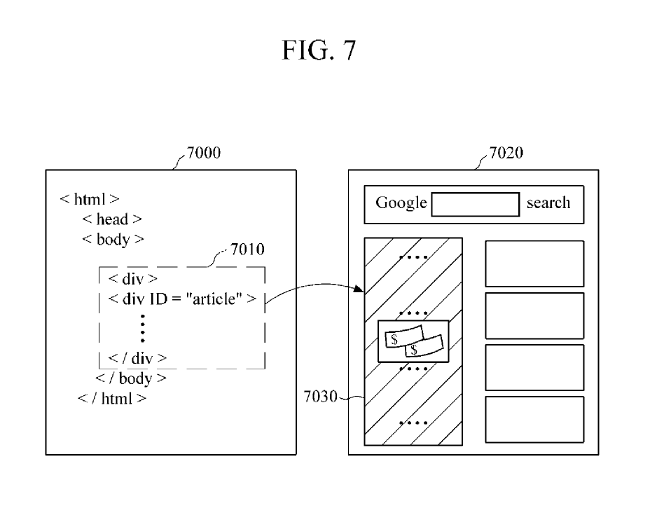

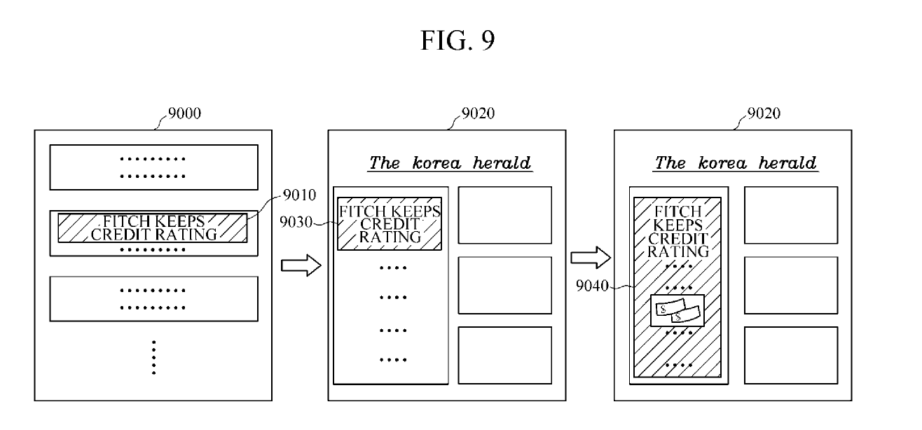

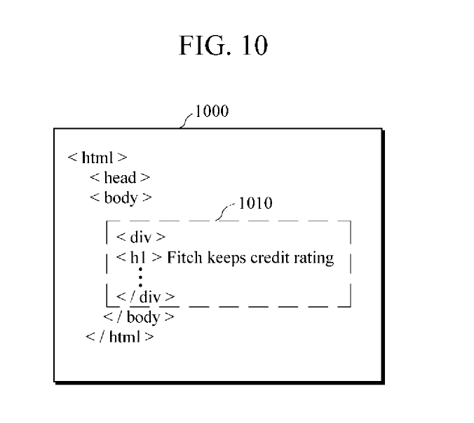

The apparatus 1 may load main elements of a webpage from the web server 2 in operation 300. The apparatus 1 may analyze the loaded main elements and determine a main paragraph among paragraphs constituting the webpage in operation 310. The apparatus 1 may extract the paragraph determined as the main paragraph from the other paragraphs, and load and render the extracted paragraphs. Examples of determining the main paragraph will be described in more detail with reference to FIG. 4, FIG. 5, FIG. 6, FIG. 7, FIG. 8, FIG. 9, FIG. 10, FIG. 11, FIG. 12, and FIG. 13.

The apparatus 1 may determine whether a sub element of the webpage is associated with the main paragraph in operation 320.

If it is determined that the sub element of the webpage is associated with the main paragraph in operation 330, the apparatus 1 may load the sub element associated with the main paragraph in operation 340. If it is determined that the sub element of the webpage is not associated with the main paragraph in operation 330, the apparatus 1 may process the sub element not associated with the main paragraph in operation 350. For example, the sub element not associated with the main paragraph may be excluded from an object to be loaded and rendered or may be replaced with a replacement sub element stored in the replacement element storage unit 18. Specifically, the sub element may be excluded from the object to be loaded and rendered by defining an attribute value for the sub element to be excluded or replaced. For example, in an HTML <img> tag corresponding to a tag for inserting an image may be modified to change the attribute ‘src’.

Further, the apparatus 1 may load a replacement element with which the sub element not associated with the main paragraph is replaced. The apparatus 1 may load a replacement element by replacing an attribute value specifying the position of a source at each node of sub elements not associated with the main paragraph with an attribute value specifying the position of the replacement element in the replacement element storage unit 18. The replacement of sub elements will be described in more detail with reference to FIG. 15.

If a user requests a webpage, the apparatus 1 may determine whether a sub element of the webpage is associated with a main paragraph, and may store information on the main paragraph based on a determined result. A user may request a modified webpage by excluding a sub element not associated with a main paragraph. If a command for requesting a modified webpage is inputted to the apparatus 1 from the user, the apparatus 1 may exclude the corresponding sub element from an object to be loaded and rendered using the information on the main paragraph stored on the main paragraph information storage unit 17 or may load a replacement element with which the sub element is replaced.

The apparatus 1 may render the selected web element and display a rendered result on the screen in operation 360.

FIG. 4 is a flowchart illustrating a method for extracting a main paragraph according to an exemplary embodiment of the present invention.

The main paragraph determination unit 112 searches for a tag node <article> in a DOM node tree obtained by structuring nodes constituting a webpage in operation 400. The main paragraph determination unit 112 may recognize a node of which name is <article> among nodes of the DOM node tree. If the tag node <article> is found, the main paragraph determination unit 112 determines the corresponding node as a node of a main paragraph in operation 410. If the tag node <article> is not found, a main paragraph determining process illustrated in FIG. 6, FIG. 8, and/or FIG. 11 may be performed.

The tag <article> is one of elements newly proposed in HTML5. The HTML5 is an evolved standard of HTML that is a basic programming language for creating a web document. In the HTML that is a previous version of the HTML5, elements for describing the structure of a layout in detail were insufficient. For example, the structure was complicated because <div> was used and a class was divided. In order to solve such problems, HTML5 logically distinguishes the web document using new elements including <article>, etc. The <article> is an element used to display an independent content unit, such as a news article or blog script in an HTML document.

FIG. 5 is a diagram illustrating a web source code for extracting a main paragraph and a screen of a webpage corresponding to the web source code according to an exemplary embodiment of the present invention.

Referring to FIG. 5, if a paragraph 5010 includes the tag <article> in an HTML source code 5000, the main paragraph determination unit 112 may determine the tag node <article> as a node of the main paragraph in the DOM node tree. A main paragraph 5030 corresponding to the tag node <article> is displayed on a screen in a webpage 5020. Data including text-based content and non-text based content corresponding to the main paragraph may be displayed on the screen regardless of whether the data is a text format. For example, an article of a text format and an image content that is a sub element related to the article may be displayed on the screen. Throughout the specification, the term “paragraph” may refer to a portion of a source code (e.g., source code 5000) corresponding to a specific webpage (e.g., webpage 5020), or may refer to a portion of content, such as text, image, hyperlink, and the like, included in the specific webpage. The term “node” or “paragraph node” may refer to a portion of a source code (e.g., source code 5000) corresponding to a specific webpage (e.g., webpage 5020) among structured nodes in a DOM node tree. Further, a main paragraph may be a paragraph including a main node of a DOM node tree. The main node may be distinguished from non-main nodes based on whether a node includes a main node indicator of the webpage. The main node indicator may include an <article> tag, a character string ‘article’ in an attribute ‘id’ or ‘class’, a text that matches to a portion or all text included in a link of previous webpage, a tag index stored in a stored main paragraph database, and the like. Further, multiple main paragraphs each associated with one or more sub elements may be extracted and displayed after a rendering process.

FIG. 6 is a flowchart illustrating a method for extracting a main paragraph according to an exemplary embodiment of the present invention.

The main paragraph determination unit 112 may search for a paragraph node including a character string “article” in an ‘id’ or ‘class’ attribute value at a tag node <div> or <table> in the DOM node tree obtained by structuring nodes constituting a webpage in operation 600. The main paragraph determination unit 112 may search for whether the character string “article” exists in the corresponding node by comparing character strings. If the tag node <div> or <table> including the character string “article” is found in the ‘id’ or ‘class’ attribute value, the main paragraph determination unit 112 may determine the corresponding node as a node of the main paragraph in operation 610. If the tag node <div> or <table> does not exist or does not include a character string “article”, a main paragraph determining process according to different criteria may be performed. For example, a main paragraph determining process illustrated in FIG. 8 or FIG. 11 may be performed.

FIG. 7 is a diagram illustrating a web source code for extracting the main paragraph and a screen of a webpage corresponding to the web source code according to an exemplary embodiment of the present invention.

Referring to FIG. 7, when the character string “article” is included in the ‘id’ or ‘class’ attribute value of a tag node <div> or <table> in a paragraph 7010 of an HTML source code 7000, the main paragraph determination unit 112 may determine the corresponding tag node <div> or <table> as a node of the main paragraph in a DOM node tree. A main paragraph 7030 corresponding to the tag node <div> or <table> including the character string “article” in the ‘id’ or ‘class’ attribute value is displayed on a screen in a webpage 7020. All data corresponding to the main paragraph may be displayed on the screen regardless of whether the data is a text format or not. For example, an article of a text format and an image content related to the article may be displayed on the screen.

FIG. 8 is a flowchart illustrating a method for extracting a main paragraph according to an exemplary embodiment of the present invention.

The main paragraph determination unit 112 may identify whether a current webpage is a page opened through a link of a previous webpage. If it is determined that a user has accessed the current webpage through the link of the previous webpage, the main paragraph determination unit 112 may search for a node having the same character string as a text of the link of the previous webpage in a DOM node tree in operation 800. For example, the main paragraph determination unit 112 may search for character strings that match to a portion of the link of previous webpage to identify whether a node including a title character string exists through the link of the previous webpage in the DOM node tree. The main paragraph determination unit 112 may determine, as the main paragraph, a webpage paragraph corresponding to a higher or the highest level node including the character strings that match to a portion of the link of previous webpage. For example, if a searched node is a node including the title of a specific news, the main paragraph determination unit 112 may determines, as the main paragraph, not only the title of the specific news but also a webpage paragraph, for example a tag node, corresponding to a higher or the highest level node including all subordinate nodes associated with the contents of the specific news.

FIG. 9 is a diagram illustrating a method for determining a main paragraph in a screen of a webpage based on a link of the previous webpage according to an exemplary embodiment of the present invention, and FIG. 10 is a diagram illustrating a web source code of the webpage including a source code corresponding to a main paragraph according to an exemplary embodiment of the present invention.

Referring to FIG. 9, a screen of a current webpage 9020 may be loaded from the previous webpage 9000 by selecting a link 9010. A main paragraph 9040 may be extracted if the main paragraph 9040 includes a portion of text 9030 that match to the text of the link 9010 in the previous webpage 9000 when a current webpage 9020 is opened through a link 9010 selected by a user in a previous webpage 9000. For example, the link 9010 selected by the user in the previous webpage 900 includes a text “Fitch keeps credit rating.” Reference numeral 9030 denotes that a webpage paragraph corresponding to a tag node including the same character string as the text “Fitch keeps credit rating” of the link 9010 of the previous webpage 9000 is displayed on a screen. Reference numeral 9040 denotes that a webpage paragraph corresponding to a higher or the highest level node including the tag node having the same character string as the text “Fitch keeps credit rating” of the link 9010 of the previous webpage 9000 is displayed on the screen. FIG. 10 illustrates a tag 1010 having the same character string as the title of a link selected by a user, for example, the text “Fitch keeps credit rating” in an HTML source code 1000.

FIG. 11 is a flowchart illustrating a method for extracting a main paragraph according to an exemplary embodiment of the present invention.

The main paragraph determination unit 112 may extract a main paragraph using information on the main paragraph stored in the main paragraph information storage unit 17. If a user selects a main paragraph of a webpage or a main paragraph is extracted according to a certain criterion, information on the selected main paragraph may be stored in the main paragraph information storage unit 17 for future reference. The information on the main paragraph may include the address of a website and information on a node of the main paragraph. The information on the node of the main paragraph may include the name of a main paragraph tag, a tag position, a tag ID, etc.

Referring to FIG. 11, the main paragraph determination unit 112 may retrieve the information on the main paragraph from the main paragraph information storage unit 17 in operation 1100. Further, the main paragraph determination unit 112 may search for a paragraph node that matches to the position of a paragraph node in the information on the main paragraph, read among nodes in the DOM node tree of the current webpage, and determines, as the main paragraph, a webpage paragraph corresponding to the searched paragraph node in operation 1110.

FIG. 12 is a diagram illustrating a screen of a webpage for extracting the main paragraph and a database included in a main paragraph information storage unit according to an exemplary embodiment of the present invention.

If the main paragraph determination unit 112 searches for a tag node identified by information on a tag index in the DOM node tree of the current webpage created with an HTML code using the information on the tag index of the information on the main paragraph stored in the main paragraph information storage unit 17, a main paragraph 1200 including the searched tag node may be displayed on the screen through a loading and rendering processes. If a webpage corresponding to a uniform resource locator (URL) stored in the main paragraph information storage unit 17 is requested, the main paragraph determination unit 112 retrieves a tag index of the URL from the main paragraph information storage unit 17 and searches for a tag index in a source code of the requested webpage that matches to the retrieved tag index of the URL. If a tag index that matches to the retrieved tag index is found, a higher tag node that includes the found tag index in the source code of the current webpage.

FIG. 13 is a flowchart illustrating a method for extracting a main paragraph according to an exemplary embodiment of the present invention.

Referring to FIG. 13, the main paragraph determination unit 112 may search for a node including tag information associated with a main paragraph in the DOM node tree of the current webpage in operation 1300. The tag information may be the main node indicator, such as an article tag, a tag including a character strings ‘article’, or an attribute associated with a main paragraph. For example, the node including tag information may be the tag node <article> described in FIG. 4, or the tag node <div> or <table> including the character string “article” in the ‘id’ or ‘class’ attribute value described in FIG. 6. In operation 1310, the main paragraph determination unit 112 may determine whether the node including tag information associated with a main paragraph is found. If the corresponding node is searched and found as determined in operation 1310, the main paragraph determination unit 112 may determine the corresponding node as a node of the main paragraph in operation 1360.

If the node of the main paragraph is not found as determined in operation 1310, the main paragraph determination unit 112 may search for a node having the same character string as a portion of the text of the link of the previous webpage in the DOM node tree of the current webpage in operation 1320. In operation 1330, the main paragraph determination unit 112 may determine whether the node having the same character string as a portion of the text of the link of the previous webpage is found. If a node having the same character string as a portion of the text of the link of the previous webpage is found as determined in operation 1330, the main paragraph determination unit 112 may determine the corresponding node as a node of the main paragraph in operation 1360. The main paragraph determination unit 112 may determine, as the node of the main paragraph, a higher node or the highest level node including the node having the same character string as the portion of the text of the link of the previous webpage.

If a node having the same character string as the portion of the text of the link of the previous webpage is not found as determined in operation 1330, the main paragraph determination unit 112 searches for the node of the main paragraph using the information on the main paragraph stored in the main paragraph information storage unit 17 in operation 1340. In operation 1350, the main paragraph determination unit 112 may determine whether the node of the main paragraph is found using the information on the main paragraph stored in the main paragraph information storage unit 17. If a node including information that matches to the information of the main paragraph stored in the main paragraph information storage unit 17 is found as determined in operation 1350, the main paragraph determination unit 112 may determine the corresponding node as the node of the main paragraph in operation 1360. If the node including information that matches to the information on the main paragraph is not found as determined in operation 1350, the main paragraph determination unit 112 may determine that the main paragraph does not exist in the webpage in operation 1370. The node search order (e.g., operations 1300, 1320, and 1340) may be changed or may be simultaneously performed. Further, although the determinations of whether the searched node is found in operations 1310, 1330, 1350 are illustrated as being separate from the node searches in operations 1300, 1320, and 1340, aspects need not be limited thereto such that the result of the node searches in operations 1300, 1320, and 1340 may indicate whether such searched node exists without the need for separate determinations.

FIG. 14 is a diagram illustrating a screen of a webpage displaying an interaction between a user and an apparatus for creating an optimized webpage according to an exemplary embodiment of the present invention.

Referring to FIG. 14, if a user selects a link 1410 on a webpage 1400, e.g., when the user selects the link 1410 by clicking the link 1410, the apparatus 1 may display a display option menu, e.g., a pop-up window for web element loading and rendering optimization, on a screen through the display unit 16. If the user selects “open main paragraph optimization 1430” among menus in the display option menu, the control unit 10 of the apparatus 1 may perform a process for performing the web element loading and rendering optimization by distinguishing a main paragraph with respect to the webpage 1440 opened through the corresponding link 1410. If the web element loading and rendering optimization is performed, all data of a paragraph 1450 determined as the main paragraph in the webpage 1440 may be displayed. However, data of a paragraph not determined as the main paragraph may not be displayed, or other replacement data may be displayed in replacement data of non-main paragraphs.

FIG. 15 is a diagram illustrating a process of displaying a replacement element in replacement of a sub element not included in a main paragraph according to an exemplary embodiment of the present invention.

Referring to FIG. 15, the sub element not included in the main paragraph may be replaced with a sub element stored in the replacement element storage unit 18 so that the replaced sub element is rendered and displayed on the screen. The replacement element with which the sub element is replaced may be rendered by changing a color attribute value or brightness attribute value of a tag node provided from the replacement element for each replacement element. For example, as shown in FIG. 15, if the original sub element is Joint Photographic Experts Group (JPEG) content, the replacement element may be displayed as a blue screen. If the original sub element is Graphics Interchange Format (GIF) content, the replacement element may be displayed as a red screen. If the original sub element is Shockwave Flash (SWF) content, the replacement element may be displayed as a yellow screen. Further, various replacement elements may be set by the user.

Further, if the user selects a replacement element displayed on a screen, the original sub element corresponding to the replacement element may be displayed on the screen. For example, if the user selects a red screen, GIF content may be displayed on the screen. If the user selects the red screen, the corresponding GIF content may be displayed on the screen while other replacement elements are displayed (e.g., the blue screen and yellow screen).

FIG. 16 is a flowchart illustrating a method for storing main paragraph information on a main paragraph selected by a user according to an exemplary embodiment of the present invention.

Referring to FIG. 16, if the user selects a main paragraph in a webpage, the apparatus 1 may display a pop-up window for inquiring whether to store the selected main paragraph. If the user selects a text ‘store information on main paragraph’ in the popup window in operation 1600, the apparatus 1 may identify whether the selected information on the main paragraph stored in the main paragraph information storage unit 17 in operation 1610. If it is determined that the selected information on the main paragraph is not stored in the main paragraph information storage unit 17, the apparatus 1 stores the information on the selected main paragraph in the main paragraph information storage unit 17 in operation 1620.

FIG. 17 is a diagram illustrating a screen of a webpage displaying an interaction between a user and an apparatus for creating a webpage which stores information on the main paragraph selected by the user according to an exemplary embodiment of the present invention.

Referring to FIG. 17, the apparatus 1 may display, on the screen, a pop-up window 1710 through which the user may select a main paragraph. If the user selects a paragraph 1720 as the main paragraph, the apparatus 1 may store the information on the selected main paragraph in the main paragraph information storage unit 17. The information on the main paragraph may include the address of a current webpage (e.g., a URL), information on a searchable index of a node of the main paragraph, etc.

FIG. 18 is a flowchart illustrating a method for displaying a sub element of a paragraph not associated with a main paragraph or not included in the web element loading and rendering optimization according to an exemplary embodiment of the present invention.

Referring to FIG. 18, after a main paragraph is loaded and rendered, a user may select a sub element and/or a paragraph in a webpage to display the sub element and/or paragraph not loaded and rendered in operation 1800. The apparatus 1 may analyze the paragraph and sub element selected by the user in operation 1810, and may determine whether the paragraph and sub element are available to load the sub element and/or the paragraph in operation 1820. If it is determined that the sub element and/or the paragraph are available to be loaded, the apparatus 1 may load the sub element and/or the paragraph in operation 1830 and perform partial rendering and layout creation in operation 1840. If no more sub element and/or paragraphs are available to be loaded, the apparatus 1 may perform completing the rendering for the sub element and paragraph selected by the user in operation 1850.

As described above, sub elements, such as contents of an image, audio or video format, which may be elements for advertisement or decoration on most webpages, may be excluded from the configuration of a webpage, thereby reducing time for providing a webpage to a user. By filtering non-essential sub elements from displaying elements on the webpage, the amount of data used in a network and system resources may also be reduced. Further, the user may see desired data without seeing the sub elements for advertisement or decoration.

Further, while non-essential sub elements of the webpage not associated with main paragraph are restricted, sub elements associated with the main paragraph, e.g., multimedia contents related to a news article, blog, etc., may be loaded and rendered to be displayed on a screen. Thus, all sub elements are not filtered and sub elements associated with a main paragraph may be selectively rendered and displayed.

When all components of a webpage are displayed using a data network, a large amount of resources and loading time used in the data network may be required. However, selective rendering and loading of main paragraphs of the corresponding webpage may reduce a waste of resources and loading time used in the data network. If a browser is connected to a data network, it may be possible to reduce the use of the data network. Further, since sub elements are selectively rendered, the rendering speed may be increased, thereby reducing the use of a battery required in the rendering of components.

It will be apparent to those of ordinary skill in the art that various modifications can be made to the exemplary embodiments of the invention described above. However, as long as modifications fall within the scope of the appended claims and their equivalents, they should not be misconstrued as a departure from the scope of the invention itself.

What is claimed is:

1. An apparatus to display a webpage, comprising:
a storage device to store webpage data for displaying a webpage;
a controller to determine a main paragraph of the webpage; and
a display unit to display the main paragraph without rendering a non-main paragraph.

2. The apparatus of claim 1, wherein the controller distinguishes the main paragraph from the non-main paragraph of the webpage based on a main node indicator.

3. The apparatus of claim 2, wherein the controller searches for the main node indicator from a source code of the webpage, and determines a main node comprising the main node indicator from a document object model node tree corresponding to the webpage.

4. The apparatus of claim 1, wherein the main paragraph corresponds to a main node of a document object model node tree of the webpage, the main node comprising a main node indicator.

5. The apparatus of claim 4, wherein the main node comprises a subordinate node comprising a sub element corresponding to an image.

6. The apparatus of claim 2, wherein the main node indicator comprises at least one of an article tag, a tag comprising a character string corresponding to an article, a text included in a link of a previous webpage, and a tag index stored in a main paragraph database of the storage device.

7. The apparatus of claim 1, wherein the display unit displays the webpage without rendering the non-main paragraph in response to a user setting.

8. The apparatus of claim 1, wherein the display unit displays a replacement element in place of a sub element corresponding to the non-main paragraph, and displays, in response to a selection of the sub element corresponding to the non-main paragraph, the sub element corresponding to the non-main paragraph.

9. The apparatus of claim 8, wherein the replacement element is determined according to a type of the sub element corresponding to the non-main paragraph.

10. A method that uses a processor to display a webpage, comprising:
loading text data of a webpage;
determining, using the processor, a main paragraph of the webpage;
rendering a sub element included in the main paragraph; and
displaying the main paragraph comprising the sub element without rendering a non-main paragraph.

11. The method of claim 10, further comprising: distinguishing the main paragraph from the non-main paragraph of the webpage based on a main node indicator.

12. The method of claim 11, further comprising:
searching for the main node indicator from a source code of the webpage; and
determining a main node comprising the main node indicator from a document object model node tree corresponding to the webpage.

13. The method of claim 10, wherein the main paragraph corresponds to a main node of a document object model node tree of the webpage, the main node comprising a main node indicator.

14. The method of claim 13, wherein the main node comprises a subordinate node comprising a sub element corresponding to an image.

15. The method of claim 11, wherein the main node indicator comprises at least one of an article tag, a tag comprising a character string corresponding to an article, a text included in a link of a previous webpage, and a tag index stored in a main paragraph database.

16. The method of claim 10, wherein the webpage is displayed without rendering the non-main paragraph in response to a user setting.

17. The method of claim 10, further comprising:
displaying a replacement element in place of a sub element corresponding to the non-main paragraph; and
rendering and displaying the sub element corresponding to the non-main paragraph in response to a selection of the non-main paragraph.

18. The method of claim 17, wherein the replacement element is determined according to a type of the sub element corresponding to the non-main paragraph.

19. An apparatus to display a webpage, comprising:
a storage device to store webpage data for displaying a webpage;
a controller to load text data of the webpage, to determine a main paragraph of the webpage, and to selectively render a sub element included in the main paragraph; and
a display unit to display the main paragraph and the rendered sub element.

20. The mobile device of claim 19, wherein the storage device stores information on the main paragraph in a main paragraph database.
